(19) United States
(12) Patent Application Publication
(10) Pub. No.: US 2021/0232662 A1
(43) Pub. Date: Jul. 29, 2021

(54) METHODS TO PROTECT STAKEHOLDERS' ALGORITHMS AND INFORMATION IN UNTRUSTED ENVIRONMENTS

(71) Applicant: NUSANTAO, INC., Cupertino, CA (US)

(72) Inventor: Raymond Vincent Corning, Lander, WY (US)

(21) Appl. No.: 17/108,950

(22) Filed: Dec. 1, 2020

Related U.S. Application Data
(60) Provisional application No. 62/967,161, filed on Jan. 29, 2020.

(51) Int. Cl. G06F 21/16; H04L 9/06; G06F 21/57

(52) U.S. Cl. CPC G06F 21/16; H04L 2209/38; G06F 21/57; H04L 9/0618

(57) ABSTRACT

A computer implemented method executed by a secure machine for securely executing a program subject to conditions specified in an agreement, e.g., smart contract, comprising: receiving a request from a user machine to execute the program and in response obtaining instructions from the smart contract; executing validation process specified in the instructions; obtaining validation approval and in response downloading the program onto the secure machine; downloading data from the user machine onto the secure machine; running the program using the data on the secure machine; transmitting output of the data from the secure machine; and, deleting the program and the data from the secure machine.

### RELATED APPLICATION

This application claims priority benefit to U.S. Provisional Application No. 62/967,161, filed Jan. 29, 2020, which is incorporated herein by reference in its entirety.

### BACKGROUND

### 1. Field

This application relates to protection of computer programs and data.

### 2. Related Art

One of the most difficult problems in the age of the internet is to effectively recall and/or delete information when we cannot fully trust the environment and/or other stakeholders involved. Once either information or algorithms (computer programs and/or artificial intelligence models) escape control of the authors and/or proper stakeholders, it is virtually impossible to recall and/or delete all copies of the program and or information.

In order to prevent loss of control of algorithms, modern corporations tend to deploy those algorithms as cloud services which they tightly control. This is the most common way to deploy sensitive algorithms securely. The problem with this approach is that penalties in privacy, security, and performance are paid. Notably, privacy and security are not controlled by the stakeholder, but rather by the cloud host.

Moving slowly to address this new issue, most vendors have embraced some form of trusted computing. Trusted computing is basically implemented using secret processor functionality and encryption key management which control the boot process and by creating trusted zones that can be accessed by the manufacturer but not by other stakeholders. The problem with the trusted computing approach is three-fold. First, security is implemented in the wrong place which makes fully securing information impractical. Second, security and privacy are not controlled and managed by the actual stakeholders. And third, a compromise of manufacturer-controlled key could lead to a compromise of systems on a vast scale, which is especially troublesome in the age of contract manufacturing.

The primary strategies for controlling information involve limiting access, encryption at rest, watermarks, and digital rights management (DRM). Limiting access to documents is effective until the access is breached and then the information can never be recalled. A classic example is a medical record that is stored in standard formats such as: Text, HTML, XML, and/or JSON. Once the document is copied and extracted from a system that limits access, the information can never be recalled. Watermarks can be bypassed by regenerating information using scanners or other techniques that convert the documents to plain text, thus removing the watermark.

The most sophisticated techniques involve the use of Digital Rights Management (DRM), which has primarily been used to protect entertainment products such as music, videos, and video games. Several problems plague current digital rights management tools: first they are applied downstream from content creation, thereby creating numerous gaps in information protection. Second, the tools are controlled by third parties and are not controlled by the various stakeholders.

Remote control is used extensively in the software field in order to deploy and configure software, usually installed on cloud infrastructure. Common tools include Fabric, Puppet, Ansible, Chef, Salt Stack, and Capistrano. The primary use of the software is to ease the deployment and maintenance of complex environments with many systems. API Stack vendors provide various tools such as: Google's TensorFlow Serving Components, AWS Outposts, AWS AppMesh, AWS Simple Workflow Service, Azure Kubernetes Services (AKS), Azure Service Fabric, Azure IOT Edge, Azure Pipelines. Open source software such as Apache Beam assist organizations with transforming data pipelines.

### 3. Problem to be Solved

There is a need to secure both algorithms (computer programs and artificial intelligence models) and information, and to ensure that control over intellectual property (whether algorithm or information) is maintained. There is also a need to make sure algorithms and information are used in the manner specified by and remain under the control of the appropriate stakeholders.

### SUMMARY

The following summary is included in order to provide a basic understanding of some aspects and features of the invention. This summary is not an extensive overview of the invention and as such it is not intended to particularly identify key or critical elements of the invention or to delineate the scope of the invention. Its sole purpose is to present some concepts of the invention in a simplified form as a prelude to the more detailed description that is presented below.

Disclosed aspects provide methods for controlling the use of information and algorithms. The methods greatly reduce information and algorithms exposure to the digital world in non-encrypted format. In addition, the proper use of both information and algorithms is addressed by: validating the environment, providing de-authentication services if necessary, ensuring that copies of data and algorithms do not remain after approved usage, ensuring data cannot be analyzed by unauthorized computer programs or artificial intelligence algorithms, and providing an evidence chain to validate authorized output that has been created.

Embodiments of the invention provide system comprising: one or more processors; a storage storing an agreement (e.g., smart contract) therein; and a non-transitory computer readable medium storing a plurality of instructions, which when executed, cause the one or more processors to, upon receiving instructions to execute a program, perform the steps: obtain the agreement from the storage; decrypt the agreement; use instructions contained within the agreement to download the program from a first specified location; use instructions contained within the agreement to download data from a second specified location; and run the program on the one or more processors using the data.

Disclosed embodiments provide a computer implemented method executed by a secure machine for securely executing a program subject to conditions specified in a smart contract, comprising: receiving a request from a user machine to execute the program and in response obtaining instructions from the smart contract; executing validation process specified in the instructions; obtaining validation approval and in response downloading the program onto the secure machine; downloading data from the user machine onto the secure machine; running the program using the data on the secure machine; transmitting output of the data from the secure machine; and, deleting the program and the data from the secure machine.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 illustrates a block diagram of data security using an embodiment referred to as edge to edge.

FIG. 2 illustrates a block diagram of data security using an embodiment referred to as neutral grounds.

FIG. 3 illustrates a general block diagram of executing a program in a verified environment, according to an embodiment.

FIG. 4 is a general diagram of data security using an embodiment referred to as executable data.

FIG. 5 is a block diagram of an example of a computing system that may be used in conjunction with one or more embodiments of the disclosure.

### DETAILED DESCRIPTION

The following detailed description provides examples that highlight certain features and aspects of the innovative digital security measures claimed herein. Different embodiments or their combinations may be used for different applications or to achieve different results or benefits. Depending on the outcome sought to be achieved, different features disclosed herein may be utilized partially or to their fullest, alone or in combination with other features, balancing advantages with requirements and constraints. Therefore, certain benefits will be highlighted with reference to different embodiments, but are not limited to the disclosed embodiments. That is, the features disclosed herein are not limited to the embodiment within which they are described, but may be “mixed and matched” with other features and incorporated in other embodiments.

In the various disclosed embodiments, program and data security is ensured by verifying the environment in which decryption and/or execution takes place, and controlling the operations permitted.

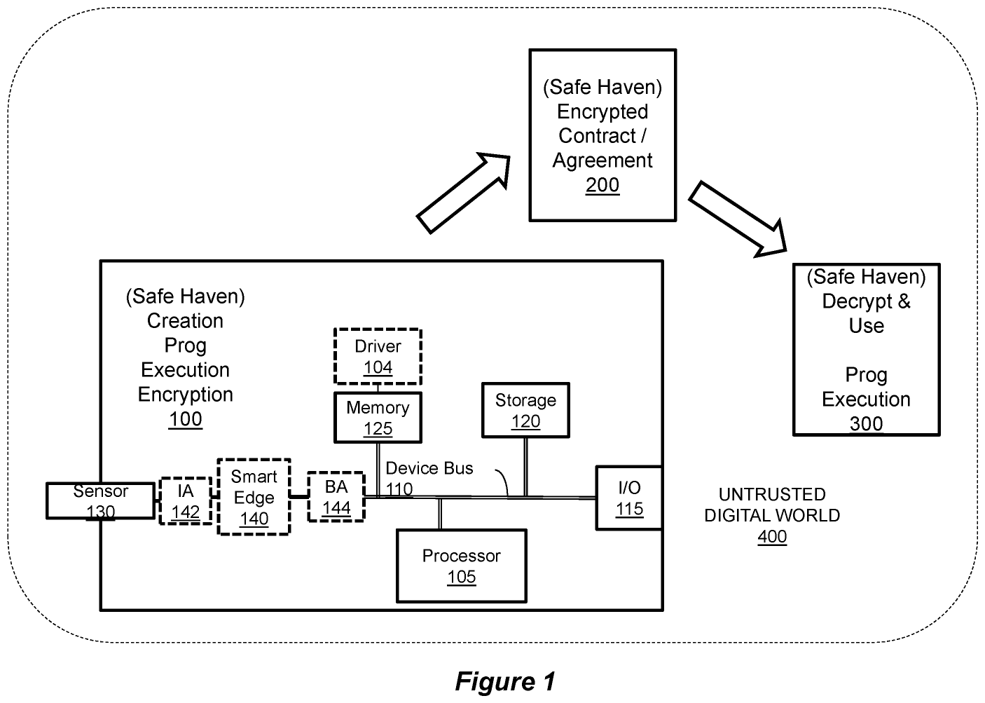

FIG. 1 is block diagram schematically illustrating control over data security in a method referred to herein as edge to edge security. Reference 100 denotes data originating device, for example, a user mobile device, an IoT device, etc. Reference 200 denotes a secure monitoring environment, such as, e.g., a secure server which provides security and validation services. Reference 300 denotes a receiving device, e.g., service provider's server. As a concrete example, data originating device may be a cellphone executing a driving direction app. The cellphone generates data, such as location coordinates. A service provider 300, e.g., Google maps, Apple, Waze, etc., receives this data and, ostensibly uses this data only to generate driving directions. However, generally the user of originating device 100 has no way of ensuring that the data is not intercepted by an unknown third party, and that the service provider 300 indeed uses the data solely to generate driving direction. The user also has no way of determining whether the user provider 300 has deleted the data after generating the driving directions.

For the most part, data of originating device 100 is generated by a sensor that forms the interface between the real world and the digital world. Examples of such sensors include a microphone, an image sensor, a GPS receiver, etc. The sensors “observe” events in the real world and generate a digital signal indicative of the event. In the embodiment of FIG. 1, the generated digital data is preprocessed and immediately encrypted at the sensor layer, which could be considered the boundary or interface between the real world and the digital world. This step minimizes the data's exposure to the digital world in an unencrypted format, especially during transmission. Any interception of the data would require decryption in order to gain access to the data.

Also, in FIG. 1 the allowable users and uses of the data are managed by an agreement/contract that may be stored and monitored by a secured security server 200. For example, the security server 200 can verify the authenticity of the server provider 300 prior to providing the encrypted data for processing. Thus, the security server 200 empowers the data originator, or stakeholder, to decide on how, when, who, how long, and for what purposes can the data be used. Note that the algorithms, data, and agreements/contracts only exist in encrypted format outside of secured edges, and when transmitted or intercepted in the untrusted digital world 400 can only be obtained in an encrypted format. The data that is encrypted upon creation is either re-encrypted in a secure area (e.g., 200) or remains encrypted until used at the point of use (300) where the data is decrypted and post processed before being used and deleted according to the permissions granted by the security server 200.

The device 100 is managed by a device processor 105 (e.g., iPhone Ax processor, Samsung's Exynos processor, Intel Core ix processors, etc.), executing instructions of an operating system (OS, e.g., Windows, iOS, WebOS, Android, etc.), and which communicates over device bus 110. In cases where the device is an IoT, the OS may include Linux, BSD (Berkeley Software Distribution OS), and BSD derivatives, or other real time operating systems such as VxWorks. The device bus 110 is connected to I/O module 115, which may include wired elements, such as Ethernet connection, and/or wireless elements, such as, e.g., WiFi, cellular, Bluetooth transceivers (not shown). Storage 120 is also attached to the bus 110, and may be used to store programs, data, etc. Memory 125 is used by processor 105 to save items needed for current processes, including running OS. Memory 125 is generally a cache memory.

Device 100 may include several sensors 130, but for simplicity only one is illustrated. Sensor 130 may be, e.g., microphone, imaging sensor, accelerometer, etc. Sensor 130 is illustrated partially outside the box of device 100, to indicate that it may be internal or external to the device 100. For example, a cellphone has an internal microphone, but may also use an external microphone as a part of a wired or wireless headset.

In the prior art devices, when sensor 130 detects a physical event (e.g., sound generated by pressure change in the case of a microphone), sensor 130 generates a signal that includes the data corresponding to the physical event. The signal of sensor 130 is sent over the device bus 110 to the processor 105. The processor 105 may operate on the signal, store the data in storage 120, and/or transmit the signal over I/O module 115. Thus, a hacker able to exploit vulnerability in the device's security system can get access to the processor 105 and/or storage 120, and thereby to the data. Similarly, a hacker able to intercept communication sent from the I/O module 115 may be able to gain access to the data.

The embodiment of FIG. 1 prevents access to the sensor data, even upon a breach of security measures. Specifically, a security module 140, referred to herein as smart edge module, is interposed between the sensor 130 and processor 105. The smart edge 140 intercepts the signal with the raw data from the sensor, prior to the signal reaching the processor 105. The smart edge 140 encrypts the data and issues an encrypted signal to the processor 105. The processor 105 only receives encrypted data, such that when the processor stores or transmits the data, it is already encrypted. Consequently, any breach which gains access to the processor 105, the storage 120, or intercepts a transmission, may only obtain the encrypted signal and thus be unable to decipher the data.

A device driver 104 resides in memory 104 and provides the communication link between the outside world and the smart edge 140, akin to a printer driver or any other device driver that enable communication with peripherals. Since driver 104 operates outside of the smart edge 140, it is considered to be operating in an insecure environment, and thus everything it handles is already encrypted. Driver 104 is responsible for transferring encrypted data to the smart edge (and sensor 130) and is responsible for transferring encrypted data to a targeted location (e.g., processor 105). Since the data handled by driver 104 is encrypted, corruption of the device driver 104 could cause an interruption of service, but could not cause a data leak.

In order to make smart edge 140 universal for all sensors and buses, an interface adapter 142 handles transmissions between the smart edge 140 and sensor 130, while bus adapter 144 handles transmissions between smart edge 140 and device bus 110. Device bus 110 may be any known bus technology, such as, e.g., Direct Memory Access, SPI, Ethernet, etc.

With the embodiment of FIG. 1, data from sensor 130 is secured and cannot be deciphered without a decryption key. Going back to the example of a hacker taking control over a camera by infiltrating the processor 105, by implementing the embodiment of FIG. 1, the hacker may only receive an encrypted transmission and will be unable to view the images from the camera, i.e., sensor 130.

In this embodiment, all elements outside of the smart edge are considered unsecured, and all elements within the smart edge are considered secured. This is ensured by prohibiting any communication into the smart edge in non-encrypted form. All inbound communications and/or data must be encrypted by a known key to be accepted and handled by the smart edge. Similarly, all outbound communication from the smart edge must first be encrypted.

Anything outside the smart edge that exists in a non-encrypted format or in an encrypted format by an unknown key is assumed unsecure. Consequently, the sensor data exists in a non-encrypted format only inside the secured smart edge. The sensor data can exit the smart edge only in a secure encrypted form. The encryption may consist of public or private key encryption technology including but not limited to Advanced Encryption Standard (AES) and/or Transport Layer Security (TLS). Decryption of the encrypted data could require multifactor authentication, using a combination of keys.

The encryption of the raw data may be performed according to instructions of a local contract stored in the module memory or a contract stored and monitored by security server 200. For increased security the contract may be a blockchain contract. The hardware random number generator and optional encryption accelerator may be used for the encryption and decryption functions. The initial key is set at the factory in the initial local agreement, e.g., smart contract, and must be replaced by the purchaser before use. The initial key is assumed to be unsecure. Incidentally, reference herein to “agreement” may include an implementation in the form of a blockchain smart contract. Also, in general, the attributes of the smart contract (SHA-256 hash or equivalent) would be stored to the blockchain and not the agreement itself.

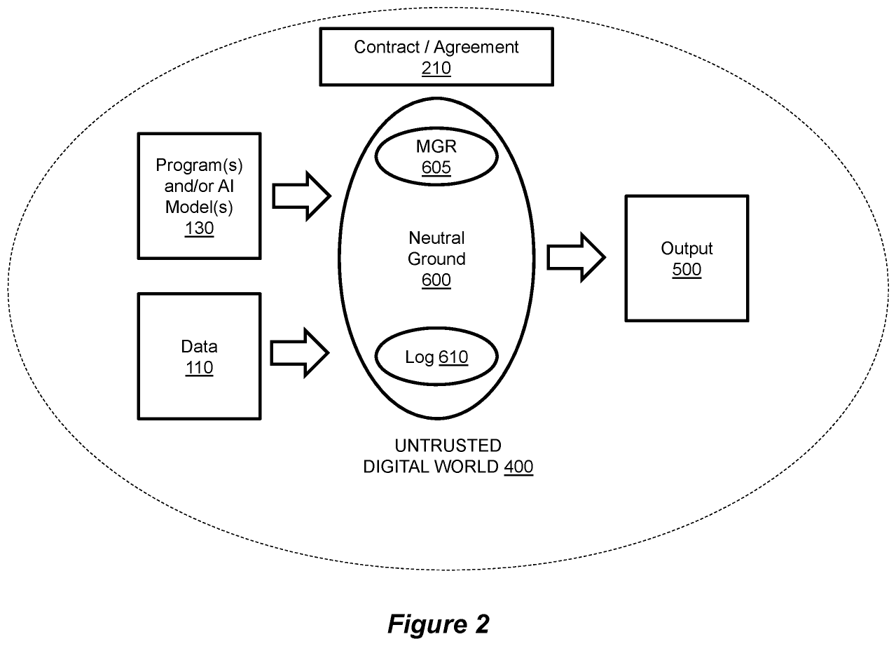

FIG. 2 illustrates an embodiment generally referred to herein as neutral ground. Computer programs and/or artificial intelligence (AI) models 130, data and/or meta data 110, and the agreement 210, e.g., smart contract, are transferred to the neutral ground 600 in encrypted format. The agreement/smart contract 210 may be downloaded onto the neutral ground 600 from a user machine, a trusted server, etc. The program 130 may be downloaded onto neutral ground 600 from the user machine, from a service provider's server, from a third party trusted server, etc. The neutral ground 600 decrypts the agreement/contract 210 and follows any rules residing in the agreement 210 to verify that the neutral ground is secured. If de-identification instructions exist in the agreement 210, data 110 is appropriately de-identified as required by the contract so that the origin of the data cannot be deciphered. Once the neutral ground 600 is validated, both data 110 and program(s) 130 are executed. Output 500 from the program(s) 130 is watermarked with hashes of both the data files 110 and the program(s) 130. Hashes of program(s) 130, data 110 and output 500 are written to the log 610, which may be blockchain or non-blockchain based. The output 500 is encrypted and transferred to the appropriate location. Next program(s) 130, data 110 and output 500 are securely deleted and a log entry to that effect is made in log 610.

To illustrate, in the context of the previous example of driving directions, the neutral ground 600 may be established and maintained by a third party, which is verified to be secure party providing such services. The third party may also maintain the agreement database 210. The program 130 may be the GPS app which is provided by service company, such as Google, Waze, Apple, etc. Under prior art operation, when the GPS location data 110 from the user is sent to the service company, the user has no control over the uses the service company may do with the data, in addition to providing GPS guidance. Moreover, the user has no control over how long the data may be stored by the service company. Therefore, in this embodiment the data is sent to the neutral ground 600. The service company also uploads an instance of the GPS app to the neutral ground. Once verified and authenticated by the manager 605, the GPS app instance is allowed to operate on the data to provide the output 500. Thereafter, if so directed by the agreement 210, the data is deleted. Moreover, the program instance may also be deleted, such that it ensures that the program may not carry any further operations.

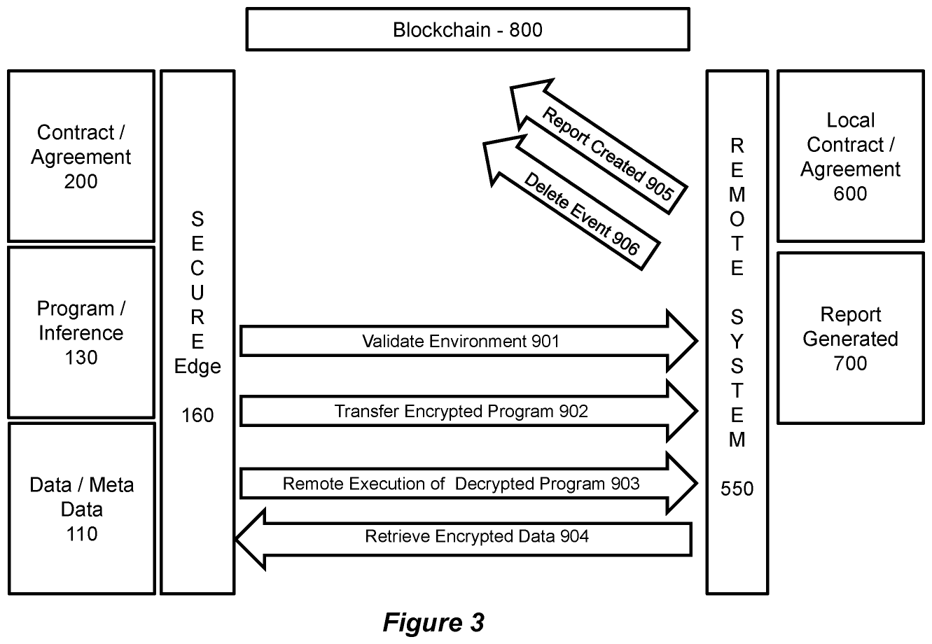

FIG. 3 illustrates a process according to an embodiment, which may be implemented in any of the systems described herein; especially those exemplified in FIGS. 1 and 2. In FIG. 3, a secure edge 140, e.g., similar to secured edge 140 of FIG. 1, intends to execute program 130 using data 110 in the secure neutral ground, which is remote system 550. To do that, in one embodiment secure edge 160 publishes a message to a message queue topic which is received by the remote system 550. Upon receipt of the message the remote system 550 opens a reverse SSH session to the secure edge 160. SSH is a network protocol that supports cryptographic communication between network nodes. Next the remote location 550 publishes a MQTT message (Message Queuing Telemetry Transport) which is received by the secure edge 160. The secure edge 160 then connects to the open SSH session which is used to transfer and then execute a remote program(s) 130 and data 110. The remote program 130 either retrieves the encrypted data stored remotely or uses encrypted data that was combined with the program to create an encrypted executable package (Executable Data).

In one implementation, executable data is implemented as a python pickle object that auto executes when the pickle object is opened running a utility program that collects information on the local environment using standard Linux utilities such as traceroute, TOP, retrieving configuration files or directory structures, or using cat to collect memory and CPU related information. The collected information is then used by a verification program running at the secure edge 160 that uses the collected environmental “finger prints” to determine a probability that the environment where the python pickle object was executed is actually the location expected and that there are no additional unwanted (e.g. malicious) programs running at the remote location 550. If the probability meets or exceed the probability threshold documented in the agreement/contract 210, a loading program residing on the secure edge 160 connects to the remote system 550, transfers a program 130, which it executes on the remote system 550. Upon executing, program 130 retrieves encrypted data stored at the secure edge 160 and uses a combination of remote and local keys to decrypt the data.

According to another embodiment, the program 130 is transferred and remotely executed using Secure Shell (SSH) to retrieve encrypted data 110, which would be decrypted using a combination of a key stored at the secure location and a key stored at the location. This method could be extended to include validation and additional verification by peer secure edges using Shamir's secret sharing algorithm or similar algorithm.

The remote system 550 may receive decryption keys from agreement/smart contract 200 or retrieves decryption keys from the locally stored agreement/contract 600, which are used to decrypt both program(s) and data 110. This helps ensure that scenarios where the secure edge 160, while it manages the process does not have actual access to the program(s), data, or portions of the agreement/contract in non-encrypted form. Once the program is decrypted at remote location it is run using secure shell (SSH) or other method of remote execution such as a RESTful API or remote procedure call from the secure edge 160. When the program has completed, it will securely delete all data and ultimately self-delete in order to ensure that neither information nor the program (s) are left behind. Output 700 that is generated is watermarked with hashes of program(s) 130, agreement (200) and data 110. A hash for the output 700 is then generated and all hashes are stored to the blockchain 800 or other appropriate log. Immediately before the program 130 self-deletes, it creates a blockchain entry that it has deleted information transferred to the remote location and is now self-deleting. The secure location may be run as a security service on a secured server or it may be run on a separate secured edge which is controlled by agreement/contract stakeholders.

FIG. 3 indicates generally the process that may be carried out according to an embodiment. Specifically, in step 901 a process is carried out to validate that remote system 550 meets trust requirements specified in smart contract 200, a copy of which 600 may be stored locally in the remote system 550. Remote system 550 executes validating steps specified in the smart contract, either initiated by smart contract 200 or locally in copy 600. Once validated, in step 902 program 130 is transferred to the remote location 550 in encrypted form. Program 130 may be transferred from secure edge 160 or from a third party server. Using instructions specified in the smart contract, the remote system 550 decrypts and executes program 130. In step 904 remote system 550 retrieves the data 110 in encrypted form and uses instructions specified in the smart contact to decrypt the data for use by program 130. The program then generates an output, indicated as report 700, and at step 905 remote system 550 issues an indication that the output was sent. At the completion of the task, remote system 550 sends an indication that the program 130 deletes itself from remote system 550.

The process flow for the embodiment of FIG. 3 may also proceeds as follows: Secure edge sends a collection utility to remote system 550. The collection utility collects data from the remote system to enable validation of the remote system 550. The collection utility sends the collected data back to secure edge 160. Secure edge 160 then executes a validation utility that analyzes the data to validate the remote system 550. If validated, secure edge sends a request to remote system 550 to retrieve the encrypted program 130. When the program has been received by the remote system 550, secure edge 160 sends a temporary decryption key to remote system 550. Remote system 550 then uses the temporary key to decrypt the program 130. Secure edge 160 then sends to remote system 550 an indication of where the encrypted data is stored and also provides decryption key. The remote system 550 then retrieves and decrypts the data.

Note that while FIG. 3 illustrates a local copy of smart contract 600, such local copy exists only when remote system is known to be secure and trusted. In other embodiment, no local copy exists and all interactions with the smart contract are either with a copy stored in the secure edge or in a separate secure location as illustrated in FIG. 1.

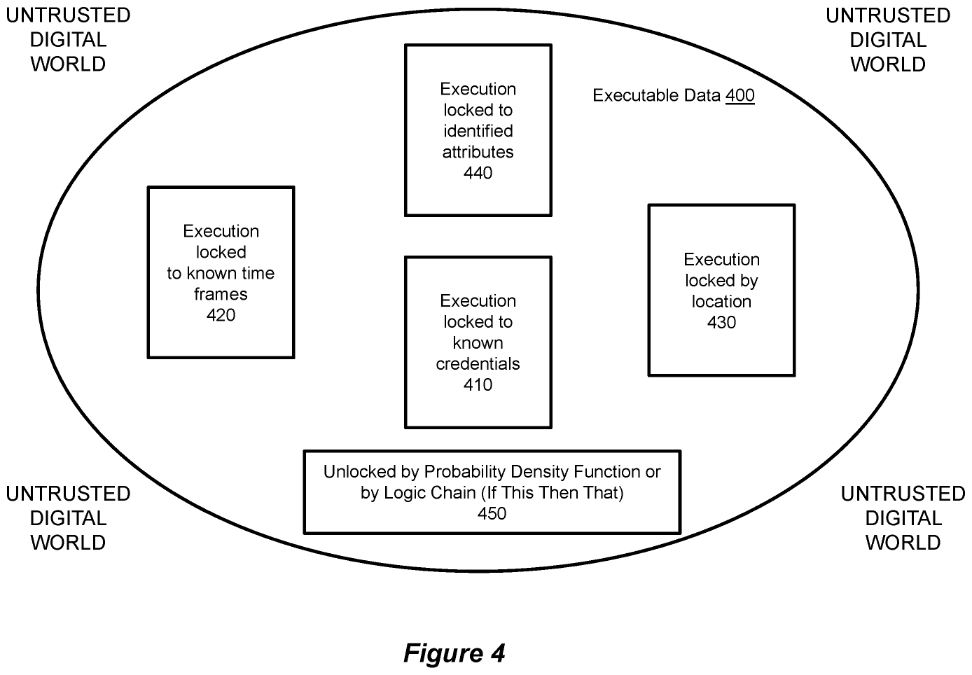

FIG. 4 illustrates an embodiment for a process that may be executed by any of the systems disclosed herein. Executable data refers to the combination of both program(s) and data. This can be done either physically through combination, encryption, and packaging or can be done logically under control of the program. In the logical example, the program is sent first, and the program retrieves the encrypted data, decrypts the data using a local key, and then continues executing. However, in general implementation the data exists only as embedded data within the program, such that the data cannot be separated from the program and cannot be used other than by the program. In a general example, it may be thought of as self-executing excel spreadsheet that incorporates the data within it. The only way the data can be used is when the excel spreadsheet executes. And then, only the output can be obtained, not the original raw data. Moreover, when the spreadsheet deletes itself, the data is also automatically deleted with it.

The embodiment of FIG. 4 is particularly beneficial for maintaining confidentiality. For example, consider a program that helps identify the persons that may have come in contact with a user who was found to test positive for COVID-19. It would be important to notify these persons so that they can be tested. However, the identity of these people, the locations where they may have come in contact with the user, and even them knowing or interacting with the user may be confidential or personal. Thus, the data of the people may be incorporated as an executable data within a program that issues notification without identifying any information from the raw data. The executable data may simply be embedded within a self-executing program that issues notification to each of the people that they should be tested. The executable data may then self-delete.

As illustrated in FIG. 4, the executable data 400 can be configured through the agreement/contract to only decrypt data and continue running if certain events or conditions have been met. These events and conditions can include but are not limited to: Time series events 420, Execution locked until various attributes or tags 440 have been identified, known credentials have been identified 410, and/or location proximity 430 has been validated through the use of tools such as GPS coordinates.

Examples of time series events 420 include: retrieving the time and date from a well-known resource such as the wall street journal website or obtaining the time/date stamp of recently created temporary files. The executable data will only execute if the date/time is within an allowed time frame specified in the agreement/contract. Time series events 420 could also be limited by access time to various resources. An example may be that a given server can be pinged, and the response time is less than 5 milliseconds demonstrating that the executable data is being executed local to know resources.

Execution locked until various attributes or tags 440 have been identified is a generic way to lock execution unless local attributes or tags exist. Examples include but are not limited to: pinging systems known to be behind a firewall, ensuring the resource is online by pinging well known resources such as the Google DNS server (8.8.8.8), checking log entries, checking server uptime, checking programs that are running using utilities such as TOP, checking disk entries for similarity to last check, checking processor, disk and/or networking card identity, comparing software installed to previous checks, etc.

Execution can be locked to location 430 either through allowing or denying based on proximity to a given location. Examples include but are not limited to: execution can occur within 500 feet of the server room, execution is allowed in specified geographical area, e.g., San Jose, Calif. Execution is denied in specified geographical area, e.g., North Korea or Iran. Execution is allowed only within the United States or its territories. Location can be determined by Global Positioning System (GPS) and/or other methods.

Execution can be locked to specified credentials 410, such as: Login credentials, biometrics, PKI (public and private keys), and/or known challenge responses (Favorite car, Favorite dog, where were you yesterday, etc).

The decision to execute 450 can be made using either static logic chains or through the use of probability-based decision-making tools such as probability densities. Static logic chains are basically tradition expert system or case-based reasoning approaches. An example would be: If processor id=123anch838 and network id=3aa:Baa:Caa and Ping of 192.189.1.10 is successful and biometric id=George Jetson then allow execution. A probability approach could be used to validate that a Network Traceroute, Disk directories structure, and software installed have a high probability of being like previous measurements.

Note that some or all of the components, modules and/or processes as shown and described herein may be implemented in software, hardware, or a combination thereof. For example, such components can be implemented as software installed and stored in a persistent storage device, which can be loaded and executed in a memory by a processor (not shown) to carry out the processes or operations described throughout this application. Alternatively, such components can be implemented as executable code programmed or embedded into dedicated hardware such as an integrated circuit (e.g., an application specific IC or ASIC), a digital signal processor (DSP), or a field programmable gate array (FPGA), which can be accessed via a corresponding driver and/or operating system from an application. Furthermore, such components can be implemented as specific hardware logic in a processor or processor core as part of an instruction set accessible by a software component via one or more specific instructions.

Although some of the processes or methods are described above in terms of some sequential operations, it should be appreciated that some of the operations described may be performed in a different order. Moreover, some operations may be performed in parallel rather than sequentially.

Embodiments include a computer program product comprising a non-transitory computer-readable medium having a computer-readable program code embodied therein to be executed by one or more processors, the program code including instructions to: receive a request from a user machine to execute an application program and in response obtaining instructions from a smart contract; execute validation process specified in the instructions; obtain validation approval and in response download the application program onto a neutral machine; download data from the user machine onto the neutral machine; run the application program using the data on the neutral machine; transmit output of the data from the neutral machine; and, delete the application program and the data from the neutral machine.

Also included is a system having a neutral server in communication with a user machine, the neutral server having one or more processors and a non-transitory computer readable medium storing a plurality of instructions, which when executed, cause the one or more processors to, upon receiving instructions to execute a program, perform the steps: obtain the smart contract from storage; decrypt the smart contract; use instructions contained within the smart contract to download the program from a first specified location; use instructions contained within the smart contract to download data from a location in the user machine; and run the program on the one or more processors using the data.

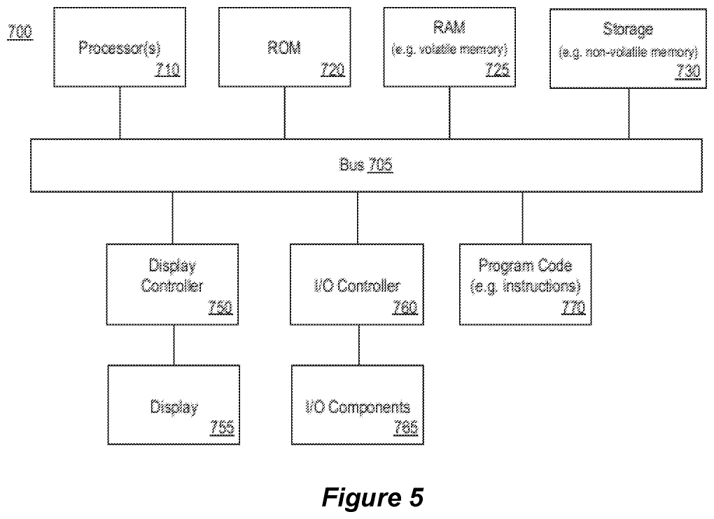

FIG. 5 shows a block diagram of an example of a computing system 700 that may be used in conjunction with one or more embodiments of the disclosure. For example, secure edge 160, remote system, program 130 or any combination thereof may represent any of the devices or systems described herein that perform any of the processes, operations, or methods of the disclosure. Note that while the computing system 700 illustrates various components, it is not intended to represent any particular architecture or manner of interconnecting the components as such details are not germane to the present disclosure. It will also be appreciated that other types of systems that have fewer or more components than shown may also be used with the present disclosure.

As shown, the computing system 700 may include a bus 705 which may be coupled to a processor 710, ROM (Read Only Memory) 720, RAM (or volatile memory) 725, and storage (or non-volatile memory) 730. The processor(s) 710 may retrieve stored instructions from one or more of the memories 720, 725, and 730 and execute the instructions to perform processes, operations, or methods described herein. These memories represent examples of a non-transitory computer-readable medium (or machine-readable medium, a computer program product, etc.) containing instructions (or program code) which when executed by a processor (or system, device, etc.), cause the processor to perform operations, processes, or methods described herein.

As referred to herein, for example, with reference to the claims, a processor may include one or more processors. Moreover, the one or more processors 710 may perform operations in an on-demand or “cloud computing” environment or as a service (e.g. within a “software as a service” (SaaS) implementation). Accordingly, the performance of operations may be distributed among the one or more processors 710, whether residing only within a single machine or deployed across a number of machines. For example, the one or more processors 710 may be located in a single geographic location (e.g. within a home environment, an office environment, or a server farm), or may be distributed across a number of geographic locations. The RAM 725 may be implemented as, for example, dynamic RAM (DRAM), or other types of memory that require power continually in order to refresh or maintain the data in the memory. Storage 730 may include, for example, magnetic, semiconductor, tape, optical, removable, non-removable, and other types of storage that maintain data even after power is removed from the system. It should be appreciated that storage 730 may be remote from the system (e.g. accessible via a network).

A display controller 750 may be coupled to the bus 705 in order to receive display data to be displayed on a display device 755, which can display any one of the user interface features or embodiments described herein and may be a local or a remote display device. The computing system 700 may also include one or more input/output (I/O) components 765 including mice, keyboards, touch screen, network interfaces, printers, speakers, and other devices. Typically, the input/output components 765 are coupled to the system through an input/output controller 760.

Program code 770 may represent any of the instructions, applications, software, libraries, toolkits, modules, components, engines, units, functions, logic, etc. as described herein (e.g. backup component 150). Program code 770 may reside, completely or at least partially, within the memories described herein (e.g. non-transitory computer-readable media), or within a processor during execution thereof by the computing system. Program code 770 may include both machine code, such as produced by a compiler, and files containing higher-level or intermediate code that may be executed by a computing system or other data processing apparatus (or machine) using an interpreter. In addition, program code 770 can be implemented as software, firmware, or functional circuitry within the computing system, or as combinations thereof. Program code 770 may also be downloaded, in whole or in part, through the use of a software development kit or toolkit that enables the creation and implementation of the described embodiments.

While this invention has been discussed in terms of exemplary embodiments of specific materials, and specific steps, it should be understood by those skilled in the art that variations of these specific examples may be made and/or used and that such structures and methods will follow from the understanding imparted by the practices described and illustrated as well as the discussions of operations as to facilitate modifications that may be made without departing from the scope of the invention defined by the appended claims.

1. A system comprising:
one or more processors;
a storage storing an agreement therein; and
a non-transitory computer readable medium storing a plurality of instructions, which when executed, cause the one or more processors to, upon receiving instructions to execute a program, perform the steps:
obtain the agreement from the storage;
decrypt the agreement;
use instructions contained within the agreement to download the program from a first specified location;
use instructions contained within the agreement to download data from a second specified location;
run the program on the one or more processors using the data.

2. The system of claim 1, wherein the one or more processors further performs the step: use instructions contained in the agreement to validate execution environment of the one or more processors.

3. The system of claim 2, wherein the one or more processors validates the execution environment by performing the steps: collecting parameters concerning the execution environment and sending the parameters to the second specified location.

4. The system of claim 1, wherein an attribute of the agreement is stored to a blockchain.

5. The system of claim 1, wherein the one or more processors further performs the step: transmit an output from the program and issues a report indicating that the output was transmitted.

6. The system of claim 5, wherein the one or more processors further performs the step: after sending the output deleting the program and the data.

7. The system of claim 6, wherein the one or more processors further performs the step: after deleting the program, sending delete indication to confirm the program was deleted.

8. A computer implemented method executed by a secure machine for securely executing a program subject to conditions specified in a agreement, comprising:
receiving a request from a user machine to execute the program and in response obtaining instructions from the agreement;
executing validation process specified in the instructions;
obtaining validation approval and in response downloading the program onto the secure machine;
downloading data from the user machine onto the secure machine;
running the program using the data on the secure machine;
transmitting output of the data from the secure machine; and,
deleting the program and the data from the secure machine.

9. The method of claim 8, further comprising transmitting validation data to the user machine.

10. The method of claim 9, wherein the program is downloaded from a service provider machine.

11. The method of claim 10, wherein executing validation process comprises collecting parameters concerning the secure machine and sending the parameters to the user machine.

12. The method of claim 10, wherein executing validation process comprises collecting parameters concerning the secure machine and sending the parameters to a validation machine.

13. The method of claim 8, wherein obtaining instructions from the agreement comprises downloading the agreement from a validation machine and decrypting the agreement in the secure machine.

14. The method of claim 8, wherein obtaining instructions from the agreement comprises downloading the agreement from the user machine and decrypting the agreement in the secure machine.

15. The method of claim 8, further comprising de-identifying the data to remove identification of its origin.

16. The method of claim 8, further comprising applying a watermark to the output with hashes of the data and the program.

17. The method of claim 16, further comprising writing the hashes of the data and the program to a log.

18. The method of claim 17, further comprising storing the log as a blockchain.

19. The method of claim 8, further comprising obtaining a key from the agreement and using the key to decrypt the program.

20. The method of claim 8, wherein executing validation process comprises transferring a validation program from the user machine to the secure machine and executing the validation program in the secure machine.
